(19) United States
(12) Patent Application Publication
(10) Pub. No.: US 2002/0084613 A1
(43) Pub. Date: Jul. 4, 2002

(54) Rolling chassis for foldable scooters

(76) Inventor: Daniel E. Freeman, Las Vegas, NV (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/754,911

(22) Filed: Jan. 4, 2001

Related U.S. Application Data
(60) Provisional application No. 60/226,273, filed on Aug. 17, 2000.

(51) Int. Cl. B62M 1/00; B62B 1/00; B62B 5/00

(52) U.S. Cl. 280/87.041; 280/652

(57) ABSTRACT

The present invention provides a rolling device that is adapted to provide a continuous rolling surface on an underside of a conventional scooter. The rolling device comprises a chassis and a series of rollers rotatably attached to the chassis, thus enabling the scooter to smoothly roll over bumps, dips, or other uneven surfaces without stopping suddenly or tipping over. The series of rollers are mounted at a uniform height that is elevated from the bottom surface of the front and rear wheels of the scooter to provide a uniform ground clearance for the scooter.

### RELATED APPLICATIONS

This application claims the benefit of U.S. Provisional Application No. 60/226,273, filed on Aug. 17, 2000 and is hereby incorporated by reference in its entirety.

### BACKGROUND OF THE INVENTION

1. Field of the Invention

This invention relates to scooters, and more particularly, to a device that enables the scooter to roll over uneven surfaces without stopping or tipping over.

2. Description of the Related Art

Scooters are becoming increasingly popular as a riding toy for children and young adults. A conventional scooter typically has an elongated frame, a front wheel and a rear wheel that are connected to opposite ends of the frame, and an upright steering assembly attached to the front end of the frame. A person can ride on the scooter by standing on the frame and holding on to the handle bar connected to the steering assembly while rolling the scooter on its front and rear wheels.

Disadvantageously, however, riders are often injured when the scooter rolls over surfaces that are not level. Because most conventional scooters are designed with low ground clearance, bumps, dips, and other uneven riding surfaces can pivot the scooter and cause the underside of its frame to hit the ground or bottom out. When the frame of a moving scooter makes contact with the ground, the scooter will most likely come to a sudden and unexpected stop. These abrupt stops are dangerous because they can cause the rider to fall over and sustain serious injuries.

Furthermore, some riders enjoy performing stunts and tricks while riding the scooter. Particularly, they like to ride the scooter over curbs, steps, and other uneven surfaces. However, most conventional scooters are not equipped for rolling across ground that is not level. In particular, as the scooter travels over curb edges, the frame of the scooter will pivot in a manner such that its front wheel becomes tilted in relation to the rear wheel, often causing the underside of the frame to wedge against the edge of the curb. Once the frame hits the edge of the curb, the scooter can stop abruptly and tip over, causing the rider to also fall over.

Hence from the foregoing, it will be appreciated that there is a need for a device that will improve the safety of scooters riders. Furthermore, it will be appreciated that there is a need for a device that will provide scooter riders a more stable ride over bumps, dips, and other uneven surfaces. To this end, there is a particular need for a rolling device that will permit scooters to roll over uneven surfaces without catching the ground and causing it to stop abruptly or tip over.

### SUMMARY OF THE INVENTION

The aforementioned needs are satisfied by the rolling device of the present invention which permits scooters to roll across uneven surfaces without stopping or tipping over.

In one aspect, the present invention provides a roller assembly for mounting under the platform section of a scooter such that a continuous rolling surface is maintained between the front and rear wheels of the scooter. The roller assembly comprises an elongated housing defining a cavity, wherein the elongated housing is sized so as to mount to the bottom surface of the platform of the scooter and extend downward therefrom.

Furthermore, the assembly also comprises a plurality of rollers that are spaced along the cavity of the elongated housing, wherein the plurality of rollers rotate about axes that extend perpendicular to the elongated axis of the cavity so as to define the continuous rolling surface. Preferably, the plurality of rollers are positioned within the cavity and sized so that when the elongated housing is mounted to the scooter platform, the continuous rolling surface defined by the plurality of rollers is maintained at a height that is elevated above the bottom surface of the front and rear wheels of the scooter. The height is substantially uniform across the continuous rolling surface so as to provide the scooter with a uniform ground clearance.

In another aspect, the present invention comprises a scooter assembly having an elongated frame, a front and rear wheel, a steering assembly that is attached to the frame, and a rolling device that is mounted to the frame. In particular, the rolling device is mounted to an underside of the frame wherein the rolling device provides a continuous rolling surface on the underside of the scooter. Furthermore, the rolling surface is substantially parallel to the horizontal plane defined by the frame of the scooter. In one embodiment, the rolling device comprises a plurality of rollers that are rotatably mounted to the frame and spaced longitudinally along the underside of the frame. In one embodiment, a first and second end of each roller are respectively attached to a pair of opposing side walls on the underside of the frame. Preferably, a plurality of axles are used to connect the rollers to the side walls of the frame. In another embodiment, the rolling device comprises a plurality of rollers that are rotatably mounted to a chassis wherein the chassis is in turn mounted to the underside of the frame. Preferably, the chassis can be mounted to the frame via double sided tape, a screw mounting mechanism, or a welding process.

In yet another aspect, the invention comprises a rolling device that is adapted to fit on an underside of a scooter. The rolling device comprises a chassis and a series of rollers rotatably connected to the chassis. Preferably, the rollers are spaced longitudinally along the chassis and rotate in a longitudinal direction with respect to the chassis. Furthermore, the rollers are mounted to the chassis in a manner so as to provide a continuous rolling surface that permits the rolling device to roll across a surface.

In one embodiment, the chassis of the rolling device comprises an elongated base and a pair of opposing side rails defining a channel therebetween. Furthermore, each roller is rotatably mounted to the side rails in a manner such that a first and second end of each roller are mounted to the opposing side rails via a plurality of axles. In one embodiment, the axles are made of stainless steel. Furthermore, the rollers are mounted on the chassis in a manner such that a portion of each roller extends a first distance beyond a lower edge of the chassis so as to provide a continuous rolling surface. In the preferred embodiment, the first distance is approximately ⅛ inch. In one embodiment, the chassis is made of a metal material such as aluminum and the rollers are made of a plastic material such as polypropylene. Furthermore, the chassis of the rolling device can be attached to the underside of a scooter via double sided tape, an expandable screw mechanism, or other suitable fastening devices.

The rolling device of the present invention is designed to provide a more continuous rolling surface on the underside of most conventional scooters. Advantageously, the rolling device permits scooters to roll over bumps, dips, curbs, steps, and other uneven surfaces without coming to an abrupt stop or tipping over. As such, the rolling device improves the safety, handling, and versatility of the scooter. These and other objects and advantages of the present invention will become apparent from the following description taken in conjunction with the accompanying drawings.

### BRIEF DESCRIPTION OF THE DRAWINGS

FIG. 1 illustrates a perspective view of a rolling device of the preferred embodiment;

FIG. 2 illustrates a side view of the rolling device of FIG. 1;

FIG. 3 illustrates a schematic cross-sectional view of a conventional scooter frame;

FIG. 4 illustrates a schematic cross-sectional view of the conventional scooter frame of FIG. 3 mounted with the rolling device of FIG. 2;

FIG. 5 illustrates a conventional scooter having the rolling device of FIG. 1 mounted to the underside of the scooter frame;

FIG. 6 is a side view of the scooter of FIG. 5 showing the rolling device of FIG. 1 mounted to the underside of the scooter.

### DETAILED DESCRIPTION OF THE PREFERRED EMBODIMENT

Reference will now be made to the drawings wherein like numerals refer to like parts throughout. As it will be described hereinbelow, the preferred embodiment of the present invention provides a rolling device that can be mounted on a conventional scooter to enable the scooter to roll over uneven surfaces without stopping or tipping over.

FIG. 1 illustrates a rolling device 100 of the preferred embodiment. As shown in FIG. 1, the rolling device 100 generally comprises a chassis 102 having an elongated base 104 and a pair of laterally opposing side rails 106a, 106b that define a channel region 108 therebetween. In one embodiment, the chassis 102 is made of a durable metal such as aluminum. Preferably, the chassis 102 is configured to fit on the underside of most conventional scooters, particularly scooters marketed under the Razor™, Micro™, and JD Bug™ brands.

As FIG. 1 shows, the rolling device 100 further comprises a plurality of rollers 114 that are longitudinally spaced along the channel 108. Each roller 114 has a first end 116a and a second end 116b that are rotatably attached to the respective side rails 106a, 106b of the chassis 102. In one embodiment, the ends 116a, 116b of the rollers 114 are attached to the side rails 106a, 106b via a plurality of fixed axles 118 that are preferably made from metal such as stainless steel. In particular, the rollers 114 rotate about axes that extend perpendicular to the elongate axis of the channel. Preferably, the rollers 114 are fabricated from a durable plastic material such as polypropylene. Furthermore, it can be appreciated that the thickness, diameter, and number of rollers may vary, depending on the length and type of scooter that will be fitted with the rolling device.

In one embodiment, the rolling device 100 also comprises an expanding screw mounting mechanism 115 that is configured to center and mount the device 100 onto the underside of the scooter in a manner to be described in greater detail below. As FIG. 1 illustrates, the screw mounting mechanism 115 comprises a plurality of screws 117a, 117b that protrude outwardly from the opposing side rails 106a, 106b. In particular, once the rolling device 100 is positioned adjacent the underside of the scooter frame in a manner described in greater detail below, the screws 117a, 117b are rotated outwardly until an outer end 119a, 119b of each screw is pressed tightly against the side walls of the scooter frame and effectively wedges the rolling device against the frame. However, it can be appreciated that the expandable screw mechanism 115 is merely one method used to attach the rolling device 100 to the scooter frame and that other fastening devices and methods can also be used to attach the rolling device 100 to the scooter without departing from the spirit of the invention.

FIG. 2 illustrates a side view of the rolling device 100. As FIG. 2 shows, the chassis 102 of the rolling device 100 has a rectangular contour. Furthermore, the rollers 114 extend slightly beyond a lower edge 120 of the chassis 102 so as to provide a continuous rolling surface 122 that enables the rolling device 100 to roll on most surfaces. Preferably, each roller 114 extends approximately 1/8 inch beyond the lower edge 120 of the chassis 102 so as to provide optimum rolling surface without significantly reducing ground clearance of the scooter. Furthermore, a strip of double sided tape 121 can be placed on a bottom surface 123 of the base 104 of the chassis 102 for mounting the chassis to the frame of a scooter.

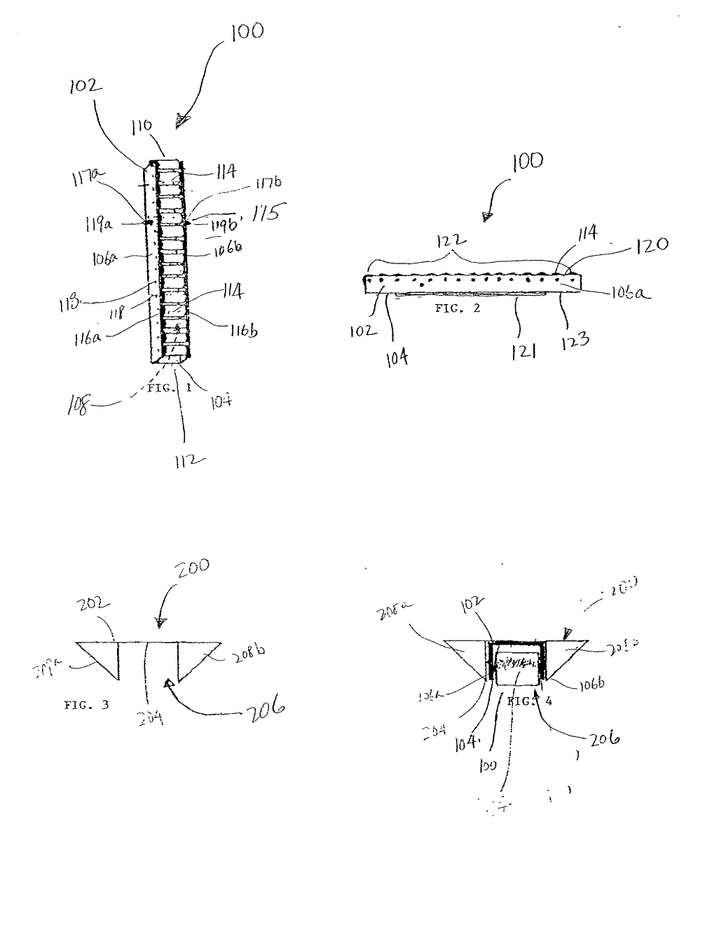

FIG. 3 is a schematic cross-sectional view of a frame 200 of a conventional lightweight, foldable scooter. As FIG. 3 shows, the frame 200 comprises an upper side 202 and an underside 204. It is generally known that the rider typically stands on a platform on the upper side 202 of the frame 200 while riding the scooter. Furthermore, it is also generally known that the rider moves the scooter by rolling a front and rear wheel that are attached to the underside 204 of the frame 200. As shown in FIG. 3, the underside 204 of the frame 200 further comprises a groove 206 defined by two opposing side walls 208a, 208b extending substantially the length of the scooter frame 200.

In one embodiment, the rolling device 100 is configured to fit into the groove 206 on the underside 204 of the scooter frame 200 in a manner as shown in FIG. 4. Preferably, the chassis 102 of the rolling device 100 is positioned inside the groove 206 in a manner such that the base 104 of the chassis 102 is pressed against the underside 204 of the scooter frame 200 while the opposing side rails 106a, 106b of the chassis 102 are placed adjacent the opposing side walls 208a, 208b on the underside 204 of the scooter frame 200. Furthermore, as FIG. 4 shows, when the chassis 102 of the rolling device 100 is mounted on the underside 204 of the scooter frame 200, the rollers 114 protrude slightly beyond the side walls 208a, 208b on the underside 204 of the scooter frame 200. Preferably, the rollers 114 protrude beyond the side walls 208a, 208b of the frame 200 by about ⅛ inch so as to provide a continuous rolling surface without significantly reducing the ground clearance of the scooter, which is typically around 1 inch for most conventional scooters. Preferably, the rolling surface provided by the rollers 114 is substantially parallel to the horizontal plane defined by the scooter frame 200 so as to provide a uniform ground clearance for the scooter.

Furthermore, as described above, double sided tape or a screw mounting mechanism can be used to attach the base 102 of the rolling device 100 to the underside 204 of the scooter frame 200. However, it can also be appreciated that various other fastening devices can also be used to mount the rolling device 100 to the scooter without departing from the scope of the invention. Advantageously, the rolling device 100 can be easily and quickly installed on most conventional scooters without the use of any tools. Furthermore, the rolling device can be mounted to a variety of types and sizes of scooters, including scooters that do not have grooves on the underside of the frame.

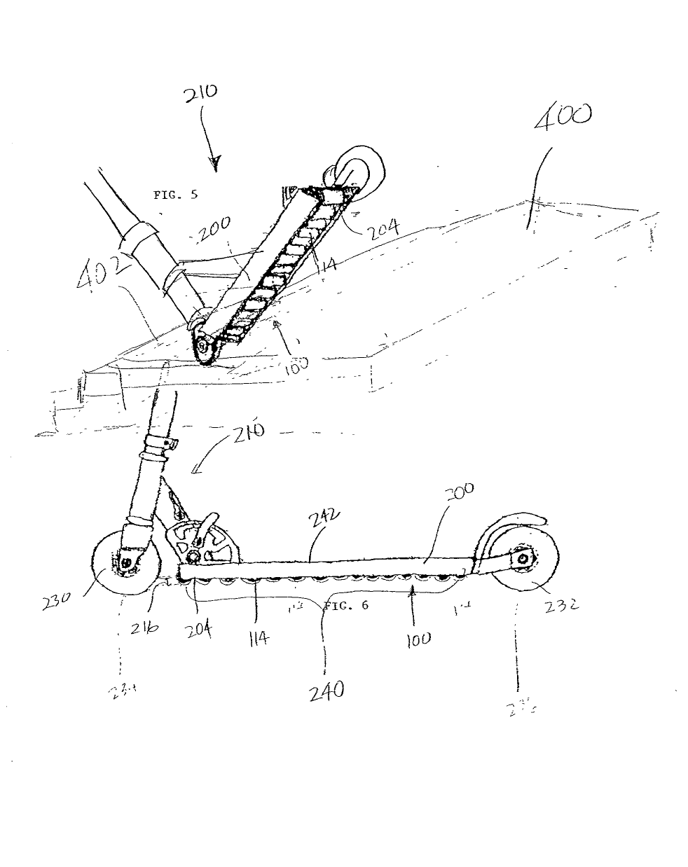

FIG. 5 is a perspective view of a conventional scooter 210 having the rolling device 100 of the preferred embodiment mounted to the underside 204 of the scooter frame 200. In particular, the rolling device 100 provides the underside 204 of the scooter 210 with a continuous rolling surface that permits the scooter 210 to glide smoothly over an edge 402 of a curb 400 as shown in FIG. 5. Advantageously, the rolling device 100 reduces the likelihood of the frame coming into contact with the ground while traveling over such uneven surfaces. As shown in FIG. 5, instead of the scooter frame 200 contacting the edge 402 of the curb 400, the rollers 114 on the rolling device 100 will make contact with the uneven rolling surface and allow the scooter to continue moving over the edge 402 of the curb.

FIG. 6 illustrates a side view of the conventional scooter 210 showing the scooter 210 having a front wheel 230, a rear wheel 232, and the rolling device 100 mounted to the underside 204 of the scooter frame 200. As FIG. 6 shows, the series of rollers 114 are longitudinally spaced along the underside 204 of the frame 200. As described above, the rollers 114 are configured to protrude a distance 216 from the underside 204 of the frame 200. The distance 216 is selected to provide a continuous rolling surface 240 for the underside of the frame 200 without significantly reducing the ground clearance of the scooter. In one embodiment, the continuous rolling surface 240 extends substantially the same length as the length of a platform 242 of the scooter 210 on which the rider can stand.

Furthermore, the rollers 114 are sized and positioned on the chassis in a manner such that when the rolling device 100 is mounted to the scooter frame 200, the continuous rolling surface 240 defined by the rollers is maintained at a height that is elevated above a bottom surface 234, 236 of the front and rear wheels 230, 232 of the scooter. As such, the rider will still be able to steer the scooter during normal riding and the rolling device is engaged only when the frame of the scooter is pivoted in a manner such that the front wheel 230 is tilted with reference to the rear wheel 232. Furthermore, it can be appreciated that other embodiments of the rolling device may comprise rollers that are not attached to a chassis and are directly mounted to the underside of the scooter.

Advantageously, during normal riding conditions, only the front and rear wheels of the scooter are engaged, permitting the scooter to turn with relative ease. The plurality of rollers 114 are engaged only when the scooter moves across uneven surfaces causing the scooter frame to pivot and the underside of the frame to come in contact with the rolling surface. Advantageously, the rollers permit the scooter 210 to glide smoothly across uneven surfaces rather than wedging its frame against the surface contours. Thus, the rolling device 100 improves the safety, performance, and versatility of the scooter.

Although the foregoing description of the preferred embodiment of the present invention has shown, described and pointed out the fundamental novel features of the invention, it will be understood that various omissions, substitutions and changes in the form of the detail of the apparatus as illustrated as well as the uses thereof, may be made by those skilled in the art, without departing from the spirit of the present invention. Consequently, the scope of the invention should not be limited to the foregoing discussions, but should be defined by the appended claims.

What is claimed is:

1. A roller assembly for mounting under the platform section of a scooter having a front and rear wheel such that a continuous rolling surface is maintained between the front and rear wheels of the scooter, the assembly comprising:
an elongate housing defining a cavity, wherein the elongate housing is sized so as to mount to the bottom surface of the platform of the scooter and extend downward therefrom; and
a plurality of rollers that are spaced along the cavity of the elongate housing, wherein the plurality of rollers rotate about axes that extend perpendicular to the elongate axis of the cavity so as to define the continuous rolling surface and wherein the plurality of rollers are positioned within the cavity and sized so that when the elongate housing is mounted to the platform of the scooter, the continuous rolling surface defined by the plurality of rollers is maintained at a substantially uniform height that is elevated above the bottom surface of the front and rear wheels of the scooter so as to provide the scooter with a uniform ground clearance.

2. The roller assembly of claim 1 wherein the housing further comprises a pair of opposing side rails extending the length of the housing wherein a first and a second end of each roller are respectively mounted to the opposing side rails of the housing.

3. The roller assembly of claim 2 wherein the first and second ends of each roller are mounted to the side rails of the housing via a plurality of axles.

4. The roller assembly of claim 2 wherein the rollers are positioned in the housing in a manner such that a portion of each roller extends a first distance beyond a lower edge of the opposing side rails of the housing.

5. The roller assembly of claim 4 wherein the first distance is approximately ⅛ inch.

6. The roller assembly of claim 1 wherein the housing is mounted to the bottom surface of the platform of the scooter via double sided tape.

7. The roller assembly of claim 1 wherein the housing is mounted to the bottom surface of the platform of the scooter via a screw mounting mechanism.

8. The roller assembly of claim 1 wherein the housing is made of a metal material.

9. The roller assembly of claim 8 wherein the metal material comprises aluminum.

10. The roller assembly of claim 1 wherein the rollers are made of a plastic material.

11. The roller assembly of claim 10 wherein the plastic material comprises polypropylene.

12. The roller assembly of claim 1 wherein the housing is mounted inside a groove formed on the bottom surface of the platform of the scooter.

13. A scooter assembly, comprising:
an elongated frame having an upper side, an underside, and two opposing ends;
a front and rear wheel wherein the wheels are attached to opposite ends of the frame wherein the wheels have substantially the same diameter;
a steering assembly having a handle bar wherein the steering assembly is attached to one end of the frame;
a rolling device that is mounted to the frame wherein the rolling device provides a continuous rolling surface on the underside of the scooter so as to permit the scooter to roll over uneven ground without stopping or tipping over wherein the continuous rolling surface is maintained at a substantially uniform height that is elevated from a bottom surface of the front and rear wheels so as to provide the scooter with a uniform ground clearance.

14. The scooter assembly of claim 13, wherein the rolling device comprises a series of rollers that are spaced longitudinally along the underside of the frame.

15. The scooter assembly of claim 14, wherein the underside of the frame has a pair of opposing side walls wherein the rollers are mounted to the side walls in a manner such that a first and second end of each roller are mounted respectively to the pair of opposing side walls and adapted to rotate in the same direction as the rotation of the front and rear wheels.

16. The scooter assembly of claim 15 wherein the rollers protrude approximately ⅛ inch from the underside of the frame of the scooter.

17. A rolling device for a scooter having a platform, a front and rear wheel attached to the platform, comprising:
a chassis that is adapted to fit on an underside of the platform of the scooter between the front and rear wheels;
a series of rollers rotatably connected to the chassis wherein the rollers are spaced longitudinally along the chassis and rotate in a longitudinal direction with respect to the chassis wherein the rollers are coupled to the chassis in a manner so as to provide a continuous rolling surface on the underside of the scooter wherein the continuous rolling surface is maintained at a substantially uniform height that is elevated above a bottom surface of the front and rear wheels so as to provide the scooter with a uniform ground clearance.

18. The rolling device of claim 17 wherein the chassis comprises an elongated base and a pair of opposing side rails defining a channel therebetween.

19. The rolling device of claim 18 wherein the rollers are positioned in the channel of the chassis wherein each roller comprises a first end and a second end wherein the first and second ends are respectively mounted to the opposing side rails of the chassis.

20. The rolling device of claim 19 wherein the first and second ends of the rollers are mounted to the side rails of the chassis via a plurality of metal axles.

21. The rolling device of claim 18 wherein the rollers are connected to the chassis in a manner such that a portion of each roller extends a first distance beyond an outer edge of the opposing side rails of the chassis.

22. The rolling device of claim 21 wherein the first distance is approximately ⅛ inch.

23. The rolling device of claim 17 wherein the chassis is coupled to the underside side of the scooter via double back tape.

24. The rolling device of claim 17 wherein the chassis is coupled to the underside of the scooter via a screw mounting mechanism.

25. The rolling device of claim 17 wherein the chassis is made of a metal material.

26. The rolling device of claim 25 wherein the metal material comprises aluminum.

27. The rolling device of claim 17 wherein the rollers are made of a plastic material.

28. The rolling device of claim 27 wherein the plastic material comprises polypropylene.

29. The rolling device of claim 17 wherein the continuous rolling surface is substantially the same length as the platform of the scooter.
